(19) United States
(12) Patent Application Publication
(10) Pub. No.: US 2005/0231467 A1
(43) Pub. Date: Oct. 20, 2005

(54) Stand alone system for storing and displaying books in electronic memory form

(76) Inventor: Charles D. Gold, Seattle, WA (US)

Correspondence Address: Clark A. Puntigam;Jensen & Puntigam, P.S., 2033 6th Ave. #1020, Seattle, WA, 98121, US

(21) Appl. No.: 11/091,792

(22) Filed: Mar. 28, 2005

Related U.S. Application Data
(60) Provisional application No. 60/556,606, filed on Mar. 26, 2004.
(60) Provisional application No. 60/556,743, filed on Mar. 26, 2004.
(60) Provisional application No. 60/578,699, filed on Jun. 10, 2004.
(60) Provisional application No. 60/587,225, filed on Jul. 10, 2004.
(60) Provisional application No. 60/605,407, filed on Aug. 27, 2004.
(60) Provisional application No. 60/604,634, filed on Aug. 25, 2004.

(51) Int. Cl. G09G 5/00

(52) U.S. Cl. 345/156

(57) ABSTRACT

The system includes a memory card, such as flash memory, containing information which would otherwise be published in conventional book form, such as a textbook, wherein the information on the card is in read-only form, and includes security elements for preventing access to the information by an unauthorized device. The system also includes a display device for receiving the memory card, reading the information in the memory card and displaying the information, wherein the display device is a stand-alone system, incapable of being connected to a network or other system so as to prevent transfer or copying of information from the display device.

### CROSS-REFERENCE TO RELATED APPLICATIONS

This application claims the priority of the following U.S. provisional applications: Ser. No. 60/556,606 filed Mar. 26, 2004, titled “Listing Software for Color Highlighting, Underlining and/or Marking of Electronic Texts in Electronic Devices”; Ser. No. 60/556,743 filed Mar. 26, 2004, titled “Business Model for Distribution of Textbooks on Portable Electronic Devices”; Ser. No. 60/578,699 filed Jun. 10, 2004, titled, “Use of Externally Attached Security Means on Electronic Memory Cards”; Ser. No. 60/587,225 filed Jul. 10, 2004, titled “Portable Electronic Reading and/or Displaying Device for Electronic Memory Cards with RFID System for Enhanced Security”; Ser. No. 60/605,407 filed Aug. 27, 2004, titled “RFID Interrogator in or on Electronic Memory Cards”; and Ser. No. 60/604,634 filed Aug. 25, 2004, titled “Recognition of RFID Signal by Electronic Memory Cards”.

### TECHNICAL FIELD

This invention relates generally to information display systems and more particularly concerns a combination of an information storage element and a display device for the information.

### BACKGROUND OF THE INVENTION

Historically, printed books have been a primary means for conveying information to users. This includes textbooks, which are used in schools and other educational institutions, but also includes books for pleasure reading as well. It is quite common for users of books to transport them in various ways, including briefcases, backpacks and book bags, among others. Such transporting of books is often cumbersome and inconvenient, however, and particularly in the case of students, who must carry a large number of books to and from school or between classes, physical strain and even injury can easily occur.

Typically, the solution to the above problem of book transport, particularly for students, has involved various means for carrying the books in a more convenient manner. These attempts include various hand carry devices, or various backpack arrangements, noted briefly above. Such articles, however, provide only minimal help in carrying books, as they do not address the fundamental issue of carrying a large number of heavy books/textbooks. The difficulty of carrying books is not as severe typically when books are being carried for pleasure reading since typically only a few such books are carried at a particular time. Yet even in those cases, the issue of bulk and weight of the book becomes a limiting factor. Constant carrying of books also results in wear and tear on the books as they are constantly lifted and often knocked about during carrying and use.

Electronic books are also known. These have some advantages over conventional books and may also have additional features, including recall, dictionary and search capability, among others. Electronic books can be delivered over the internet (World Wide Web). However electronic books and internet delivery systems present significant issues for book publishers, including copyright infringement/piracy and interruption of their traditional distribution process.

Hence, it would be desirable to have a system for conveniently carrying books, including textbooks, without the cumbersome nature of and inconvenience of conventional books and at the same time avoiding piracy and other possible disadvantages of electronic books.

### SUMMARY OF THE INVENTION

Accordingly, the present invention is a system for storing and displaying information in books using a small, high density storage medium, comprising: a small, lightweight, memory element for containing information otherwise published in conventional book form, wherein the memory element includes means for preventing copying or transferring information from the card to another media element, and a display device for receiving the memory element and for reading and displaying the information contained therein, under control of a user, the display device including means for preventing transferring information from the display device to any other system.

### BRIEF DESCRIPTION OF THE DRAWINGS

FIG. 1 is a schematic view showing the basic system of the present invention.

FIGS. 2A-2D are schematic views showing selected security features of the present system.

FIG. 3 is a schematic view showing a particular aspect of the present system.

FIG. 4 is a schematic view showing another aspect of the present system.

FIG. 5 is a schematic view showing yet another aspect of the system of the present invention.

### BEST MODE FOR CARRYING OUT THE INVENTION

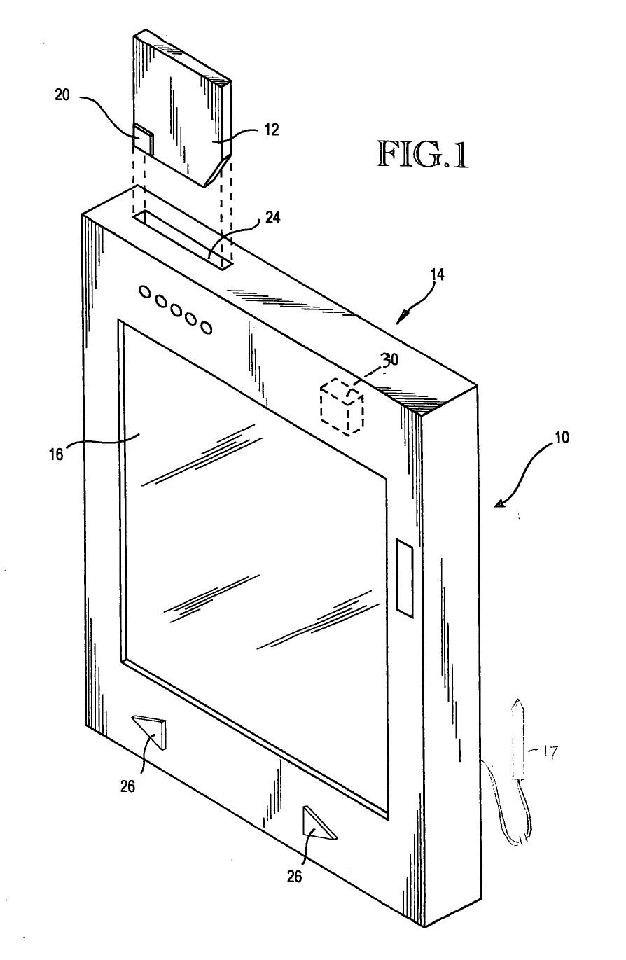

Referring to FIG. 1, the present system 10 includes a small electronic memory card 12 such as “flash memory”, on which is stored the information, including text and illustrations, usually contained in a conventional book, for instance a textbook. The system further includes a display device 14 which includes a display screen 16 of a selected size. This system 10 allows the convenient transport of a large number of books in a convenient carrying case (not shown) or other means of transport. The carrying case can for instance include one large pocket or receptacle for carrying the display device 14 and a plurality of smaller pockets for carrying the individual memory cards, each of which contains a part of or a complete textbook or other book. The display device may be secured by Velcro or other attachment means. The carrying case can also include a space or pocket for a notebook for use in making notes about the book, class notes or the like. This system 10 eliminates the physical strain and inconvenience of carrying around a large number of separate books which are in many cases even individually quite heavy.

The electronic memory card 12 is a conventional electronic data storage element such as for instance a compact flash memory card, or other similar card or device. Various small memory elements can be used. They should be reasonably rugged. The memory devices are quite small, compact and lightweight, usually less than one ounce, and are otherwise suitable for being conveniently stored in a carrying case. The book material stored on the memory card would typically be the information comprising a conventional printed book such as a text book. This can include text as well as illustrations and/or photographs present in the book.

Typically, the information will be stored in a read only format, thereby providing security from either being modified, copied or transferred to another storage device from which the material could be either copied or transmitted further without the permission of the owner of the copyright on the material. The memory card 12 can also include conventional anti-theft/tampering software 20 which will disable the use of the card or information on the card if tampering is detected. The memory card may also include various security features, which are discussed in more detail below.

The display system 14 as indicated above includes a screen 16 which can be of various sizes. The display could be a touch screen, liquid crystal display, LED display or other electronic display. Display system 14 is not capable of being connected to any transmission device or external network or other device, including internet, telephone or other network, to insure the security of the material on the memory card and to prevent the material being displayed from being copied or otherwise disseminated in any way. The display device includes no electronic data input or output capability to prevent any communication of data to or from the device. The display device also includes a capability of disabling itself, temporarily or permanently, if it is tampered with such as by attempting to open its case.

The display device is capable of displaying the information on the memory card upon insertion of the card into the display system entry port 24, or with other action of the user, such as a switch. The display device includes a conventional processor with software 30 which processes (reads) the information stored in coded form on the electronic memory card 12 and then displays it in human recognizable form on the display screen 16. Forward and reverse “page turning” reading controls 26 as well as other display controls, such as contrast, brightness, text quality and size etc.) permit the user to move through the material at a desired speed (forward or back) or manage various image factors. The controls can further include fast forward and rewind, if desired, to increase the speed of the scanning of the text. In addition, further controls can be provided to immediately locate a particular portion of the text, for instance a selected chapter in a multi-chapter book. The controls can be in the form of buttons or other finger generated controls. An electronic menu for function control is also possible.

The display device 14 may also include an anti-tampering feature in its software 30 as well as a verification capability for an inserted memory card carried out prior to the information therein being read and displayed. This verification system could include for instance, a coded signal transmitted from the display device 14 to the inserted memory card 12 or vice versa, to initiate the processing and display of the memory card.

One significant feature of the present system includes a software capability of highlighting text on the electronic display with selected colors and a marking element, using a touch screen and an electronic or other type of stylus. The software capability to highlight and/or underline or otherwise mark a section of text in an electronic display generally is known in other digital information formats and hence is not described in detail here. However, the ability to highlight particular portions of the displayed text is a significant feature of the combination system involving a memory card containing a book, such as a textbook, and a stand alone reader/display device. The marked material may be transferred to another element in the display device but cannot be transmitted out of the device.

The user can electronically mark parts of the text or illustrations which the user is reading or studying. Different colors can be used. Remarks or notes can be added to the margins if desired, although this is not necessary to the basic system Further, the software has the ability to recall the marked or highlighted parts in a list form sorted for instance by color or other criteria. For instance all of text highlighted in yellow could be displayed together. Some or all of the information in the lists could include the chapter number, chapter title, page number or other identifying information for each highlighted portion in the list.

Searching of the full text or just the highlighted information can be done and the results listed on the basis of key words, in addition to colors. The listing ability in the present system permits grouping of information without having to create a new electronic document. The display of a particular list can be accomplished by the user with a simple manually implemented command to the device identifying the particular desired list. One example could be simply holding down the button which activated the particular desired highlighting function for a pre-selected period of time, e.g. longer than 3 seconds. The basic concept involves a two step software controlled process, in which the text is first electronically marked in some fashion, either by highlighting or underlining by the user, with the user then selecting a particular list identified by a button or other manually-operated member, in accordance with selected list criteria. Again, highlighting of material electronically is generally known but not as part of software controlling the display in the present combination system.

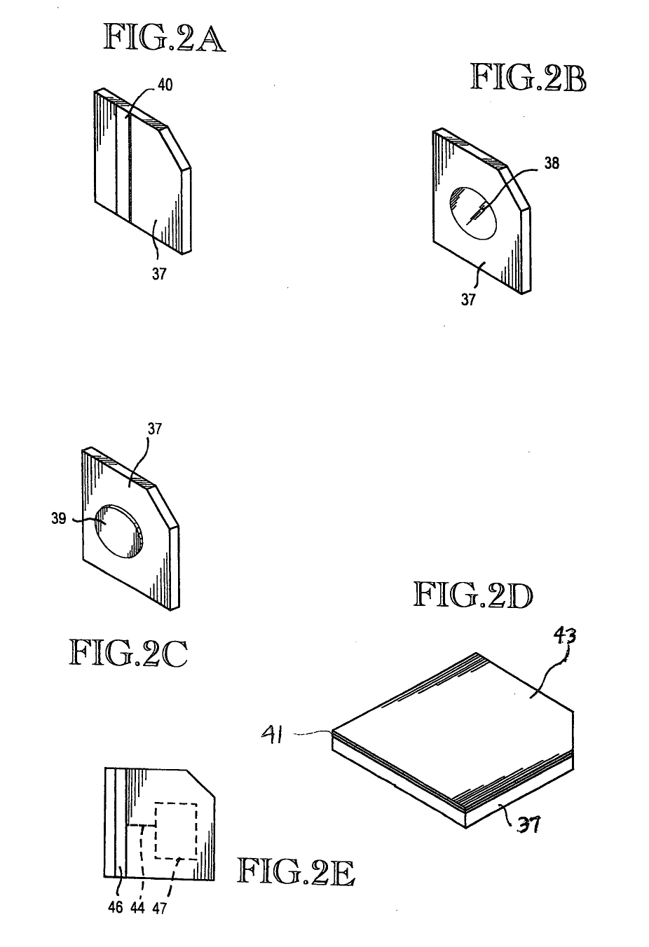

Another aspect of the present system includes a security element or elements which may be placed on the memory card 12. The security element typically is added to the memory card before the content although it may be an integral part of the card when manufactured, and provided with security instructions before, during or after the time when the book content is provided on the card. The external security may include an RFID (radio frequency identification) means which is discussed in more detail below, as well as other magnetic, optical, or electronic security means. This can be done in the form of a label or tag, strip or spot on the card 37. This is shown for instance at 38 in FIG. 2B which is a spot or at 39 in FIG. 2C or can be in the form of a magnetic strip 40 as shown in FIG. 2A. The external security element can be separated from the surface of the electronic memory card by an insulating barrier 41, if desired, to prevent signal interference between the memory card and the security element. The security element could also be electrically connected to the internal electronic circuits of the memory card, if desired, so that it can cause some action in the memory card, including an on-off function to enable the display of the content of the memory element, with or without going through the processor in the display device.

The display device 14 will have the ability to recognize the security element present on the memory card. If the device finds the security information provided back by the security element acceptable, access to the content on the memory card by the device is then permitted. This assures for instance that a particular memory card is accessible only by a specific display device, if such a function is desired. If, for instance, an errant memory card with a particular type of security element is inserted into a display device which is not authorized to display that memory card, the display device would be unable to recognize the signal from the security element and would not be able to open the book information present on the memory card for display.

The security element can be positioned on the memory cards in various locations; for instance, it could be placed relatively near the bottom of the card so that verification of the card can be accomplished before contact is made with the stored information. It is also possible that the security element could be positioned so that the verification could occur at any point following insertion of the memory card.

As discussed briefly above, a security element 46 on a memory card could be connected via an electrical link 44 to the memory circuits 47 in the card. In this embodiment, a signal from the display device could be generated upon verification of the electronic card, the signal being applied to the electronic circuits in the card over the electrical link. The information on the card is only accessible to the display device if the signal from the security element is received.

Also, as briefly indicated above, the security element could have the capability of responding to an attempt to tamper with the security element or the electronic memory card itself or to an unauthorized attempt to access the content of the memory card to either permanently disable or temporarily scramble the information on the memory card.

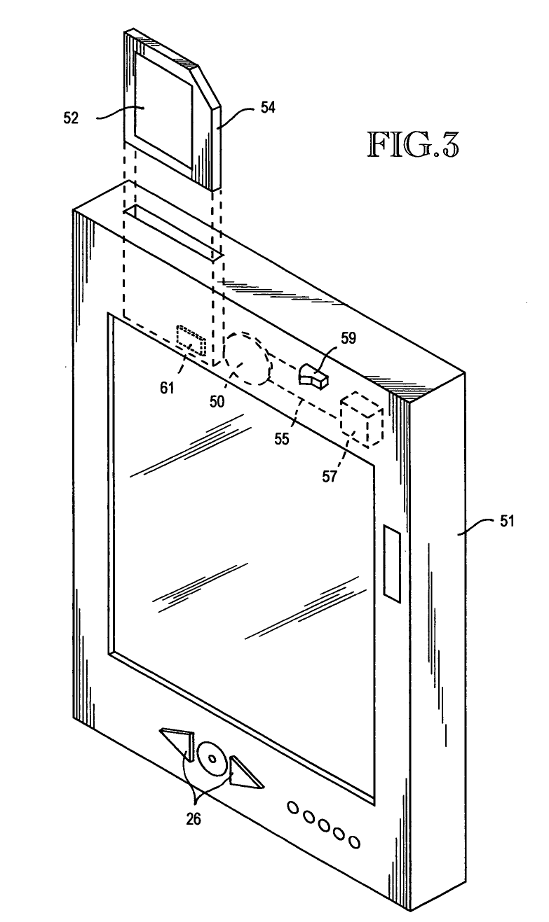

An additional or alternate security means can be used to provide further security to the system. This additional security uses RFID (radio frequency identification) capability. It is possible that a conventional security element discussed above as well as encryption methods may not provide adequate security to protect uncontrolled and undesired access to the information on the memory card. Such conventional security strategies can often be defeated electronically or by other means. RFID can provide an additional level of security to that discussed above or may be sufficient by itself. In this arrangement, referring to FIG. 3, a RFID system includes an interrogator member/reader 50, sometimes also referred to as a base station, in or on the display device 51, and an RFID label or tag 52 attached to or incorporated in memory card 54, with an electrical connection 55 between the RFID reader and the display device processor 57. The RFID system may obtain its power from the display device or it may have its own separate power source.

The RFID interrogator reader may be operated by a control switch 59 to activate its operation only when an electronic memory card 54 is inserted into the display device 51, or activation of the system could be accomplished by physical contact between the inserted memory card and a contact element 61 in the receptacle for the card in the display device. A timer could also be used at the RFID interrogator reader to automatically turn power off to the RFID device after a period of time long enough for communication to occur between the reader and the tag on the memory card.

The RFID label 52 contains information which is communicated to the RFID reader following receipt of the interrogator signal. The RFID system increases the reliability of the overall security of the system. The RFID reader 50 in the display device determines, following communication from the RFID label, that the memory card carrying the interrogated RFID label is approved for use in the display device and consequent display of the contents on the card. The RFID label may, in addition, contain accumulated information about previous access attempts and times thereof, all of which can be ascertained by the reader in the display device.

If the RFID reader 50 determines that from the information received back from the RFID label 52 that the memory card contents may be displayed, RFID reader 50 will signal the memory card to open all or part of its stored contents to the display device. This can be done with a signal from the RFID reader 50 or the display device 51 itself can provide a trigger signal to the memory card.

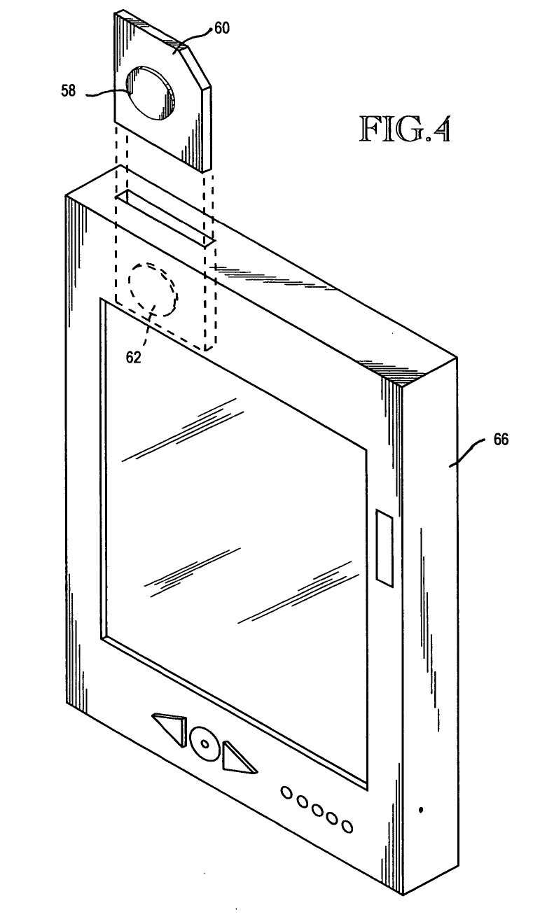

Alternatively, referring to FIG. 4, a surface mounted (or internal) RFID interrogator/reader 58 can be positioned on electronic memory card 60 with an RFID tag or label 62 in the display device 66. The interrogator/reader 58 verifies that the display device 66 is authorized to read and display the contents of the particular memory card inserted in the display device. Typically, there will be an electrical connection between the interrogator/reader 58 on the memory card and the memory circuits on the card to allow the electronic memory card to be used in the display device. Hence, the interrogator/reader on the card can provide a signal to the display device to permit processing and display of the information on the card by the display device or the interrogator/reader can provide a signal to the electronic circuits on the card permitting access to the contents thereof by the display device. As another alternative, both the memory card and the display device could have RFID interrogator/readers, a “double” interrogator/reader arrangement.

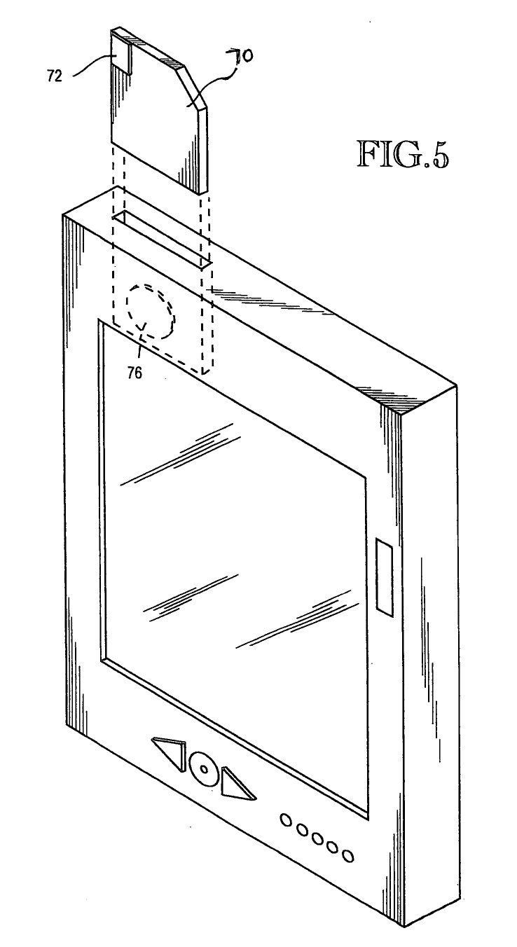

As an additional feature of an RFID system, referring to FIG. 5, individual electronic memory cards 70 may include a system 72, in addition to an RFID label or in the absence thereof, for determining that the card has been interrogated by an RFID interrogator/reader 76. The detection capability can work separately or in conjunction with the normal function of the RFID identification label. The system 70 could be capable of detecting an RFID inquiry at a particular frequency or frequencies or at all frequencies. This detection system could include an antenna, which recognizes an RFID transmission or other material that responds to an RF (radio frequency) transmission by physical expansion or other change of state to activate a switch in the electronic circuits or the memory card. The system 70, upon detection of the RFID inquiry will increment the previous number of inquiries made to it and can then further trigger a response in the memory card, for instance, disabling the card upon an unauthorized or incorrect RFID inquiry or enabling the RFID inquiry to be completed following a selected time beyond an authorized RFID inquiry. A system 70 could also be used on a memory card without an RFID element to permit access to its content when receipt of an RFID interrogation signal is recognized. The RFID inquiry triggers a response in the memory card, such as an electronic on-off switch or other sequence, for access to the contents stored on the card. The memory card could have means to use the energy from the RFID interrogator to produce the desired response/function in the card. Hence an RFID security capability can be obtained in the absence of an RFID element on the memory card. This particular RFID arrangement for a memory card can be used in system other than the display system disclosed herein.

Hence, a system has been disclosed for convenient storage of book information, including particularly textbooks, on a small, lightweight, easy to carry electronic memory card. The contents of the memory card can be processed and displayed as well as marked by the user in the form of a software controlled display device. The system can include various security controls, including various RFID systems.

The above-described system is adapted for use particularly with students attending a school. A package or kit is provided by the school or other authorized entity to the student. The combination package/kit includes the display device, textbooks for a particular class or classes on flash memory cards or similar high density storage media and a carrying case which is enhanced with pockets or containers to carry the display device and the memory cards for convenient access. A notebook can also be included. The school or other organization can make the package/kit available to the students or to parents on behalf of the students for purchase or lease.

A feature of this method is that while textbooks per se are eliminated, the normal economic marketing chain of textbook providers is not interrupted, apart from the contribution of the printing industry, since the owners of the copyright on the text will be still in a position to provide the textbooks, albeit in a different form, to the schools. Copyright rights are protected under this system. The distribution method will include the security protections discussed above with respect to both the memory and the display device, to prevent unauthorized copying or transmission of the material on the memory cards, and if desired, provide security protection to ensure that only authorized memory cards and authorized display devices are used in the system.

Although a preferred embodiment of the system disclosed herein has been disclosed for purposes of illustration, it should be understood that various changes, modifications or substitution may be incorporated in the embodiment without departing from the spirit of the invention which is defined by the claims which follow.

1. A system for storing and displaying information in books using a small, high density storage medium, comprising:
a small, lightweight, memory element for containing information otherwise published in conventional book form, wherein the memory element includes means for preventing access to the information by an unauthorized device; and
a display device for receiving the memory element and for reading and displaying the information contained therein, under control of a user, the display device including means for preventing transferring information from the display device to any other system apart from the display device.

2. The system of claim 1, including means for detecting an attempt to tamper with the memory card and for at least temporarily disabling reading of the memory card upon recognition of said tampering.

3. The system of claim 1, wherein the memory element is a flash memory card.

4. The system of claim 1 wherein the display device includes means for marking selected portions of the displayed text with at least one type of indicia.

5. The system of claim 4, wherein said marking means includes marking with more than one indicia.

6. The system of claim 4, when the indicia are different colors of highlighting.

7. The system of claim 4, when the indicia is underlining.

8. The system of claim 4, including means for collecting and displaying together all the portions of the displayed text marked by one type of indicia.

9. The system of claim 8, including a display of the location in the text material of each of said portions.

10. The system of claim 1, including a non radio frequency identification (RFID) security element on the memory element and a reader in the display device for confirming the presence of an authorized security element on or in the memory element and thereafter permitting the information in the card to be read and displayed by the display device.

11. The system of claim 1, including a radio frequency identification (RFID) element on the memory card and an RFID interrogator/reader on the display device for verifying that the memory card is authorized for use by the display device.

12. The system of claim 1, including a radio frequency identification (RFID) element on the display device and an RFID interrogator/reader on the memory card for verifying that the display device is authorized to use the memory card.

13. The system of claim 1, including a radio frequency identification (RFID) interrogator/reader and associated RFID elements on both the memory card and the display device.

14. The system of claim 11, including means on the memory element for ascertaining and then indicating when the RFID element has been interrogated by an RFID interrogator device.

15. The system of claim 1, including means on the memory element for ascertaining when the memory element has been interrogated by a radio frequency identification (RFID) interrogator device and then permitting access to the information on the memory card.

16. The system of claim 10, wherein the security element includes a security code, and further includes means electrically insulating the security element from the memory element.

17. The system of claim 10, including an RFID security system in addition to the non RFID security system.

18. The system of claim 12, including an electrical connection between the RFID element and memory circuits in the memory element and signal means in the memory element for communicating to the circuit that reading and display of the information is authorized.

19. A method of distributing a system for storing and displaying of information otherwise contained in books using small, lightweight storage media, comprising the steps of:
assembling a kit including at least one small memory element containing information otherwise published in conventional book form, the memory element being substantially smaller and lighter than the corresponding book, wherein the memory element includes means for preventing access to the information by an unauthorized device, wherein the memory element contains the text of a book which is pre-selected for a particular course or year of study in a school; a display device for receiving the memory cards and displaying the information contained therein, wherein the display device contains means for preventing transferring information from the display device to another system or copying the information and is characterized by a lack of data input and output connections and further includes means preventing connection to a network or other external electronic device and a carrying case for receiving and carrying the display device and the individual memory cards for said study; and
making available to a student enrolled in said course of study one of said kits for use in the course of study.

20. The method of claim 19, including a plurality of memory elements in the kit, for storing the contents of a plurality of textbooks.

21. The method of claim 19, wherein the kit of materials is made available by said school.

22. The method of claim 19, wherein the kit of materials is made available by an organization other than said school but authorized by said school.

23. The method of claim 19, wherein the kit of materials may be either purchased or leased by or on behalf of the student.

24. The system of claim 10, wherein the security element is a magnetic element.

25. The system of claim 24, wherein the magnetic element is in the form of a strip or a spot.

26. The system of claim 10, wherein the security element is an optical element.

27. The system of claim 26, wherein the optical element is in the form of a strip or a spot.

28. The system of claim 10, wherein the security element is an electronic security code.

29. The system of claim 1, including an RFID element on the memory card which, in response to a signal from an RFID interrogator indicating that the information on the memory card can be accessed, transmits a signal which permits access to the information on the card.

30. A secure memory device, comprising:
a memory element for storing book information in electronic form, wherein the memory element includes a radio frequency identification (RFID) system which prevents unauthorized access to the information on the card.

31. The system of claim 30, wherein the memory element is a removable storage media which includes flash memory.

32. A memory device comprising:
information in electronic form; and
a radio frequency identification mechanism for preventing unauthorized access to the information.

33. The device of claim 32, wherein the information is book information.

34. The device of claim 32, wherein the information is copyrighted information.

35. The device of claim 32, wherein the device is a flash memory card removable storage media.

36. The device of claim 33, wherein the book information is text or illustration.

37. A secure memory device, comprising:
a removable storage media memory card with a mechanism for recognizing a radio frequency identification transmission; and
an electronic switching mechanism in the memory card that responds to the recognition of an authorized transmission by allowing the electronic contents stored on the memory card to be accessed.
